(19) United States
(12) Patent Application Publication
(10) Pub. No.: US 2021/0130593 A1
(43) Pub. Date: May 6, 2021

(54) TIRE TREAD BASED ON A HIGHLY SATURATED DIENE ELASTOMER

(71) Applicant: COMPAGNIE GENERALE DES ETABLISSEMENTS MICHELIN, Clermont-Ferrand (FR)

(72) Inventors: José-Carlos ARAUJO DA SILVA, Clermont-Ferrand Cedex 9 (FR); Aurélie TRIGUEL, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/603,546

(22) PCT Filed: Apr. 5, 2018
(86) PCT No.: PCT/FR2018/050849

§ 371 Date: Oct. 7, 2019

(30) Foreign Application Priority Data
Apr. 10, 2017 (FR) 17/53106

(51) Int. Cl. C08L 23/08; B29B 7/00; B60C 1/00; B60C 11/00; C08K 3/04

(52) U.S. Cl. CPC C08L 23/083; B29B 7/002; B29K 2009/00; B60C 11/0008; C08K 3/04; B60C 1/0016

(57) ABSTRACT

A tire tread comprising a rubber composition based on at least one highly saturated elastomer, a reinforcing filler and a vulcanization system is provided. The highly saturated diene elastomer contains 1,3-diene units and more than 50 mol % of ethylene units, the vulcanization system comprises a dithiosulfate salt of formula MO₃S-S-A-S-SO₃M in which the symbol A represents an alkanediyl group or a group comprising two or more alkanediyl units, which units are connected in pairs by means of an oxygen or sulfur atom, of a group of formula —SO₂—, —NH—, —NH₂⁺—, —N(C₁—C₁₆ alkyl)- or —COO—, or of an arylene or cycloalkylene group and the symbol M represents a metal atom. An improved compromise between the bubbling of the tread at the exit of curing presses and its hysteresis can be achieved.

This application is a 371 national phase entry of PCT/FR2018/050849 filed on 5 Apr. 2018, which claims benefit of French Patent Application No. 17/53106, filed 10 Apr. 2017, the entire contents of which are incorporated herein by reference for all purposes.

### BACKGROUND

### 1. Technical Field

The present invention relates to tire treads.

### 2. Related Art

Ideally, a tire tread must fulfill a great many technical requirements, which are often contradictory in nature, including increased wear resistance while affording the tire low rolling resistance.

To improve the wear resistance, it is known that a certain stiffness of the tread is desirable. It is known from patent application WO 2014/114607 that this stiffening of the tread can be obtained for example using highly saturated elastomers. These highly saturated elastomers also have the advantage of conferring on the rubber compositions a compromise between the stiffness and hysteresis properties different from the highly unsaturated diene elastomers conventionally used in rubber compositions, such as, for example, polybutadienes, polyisoprenes and copolymers of butadiene and styrene.

For one and the same elastomer, the level of stiffness of the rubber composition is also defined by the degree of vulcanization of the elastomer which depends both on the vulcanization kinetics and the residence time of the rubber composition in the curing press. It is known that rubber compositions continue to cure, even once they have been removed from curing presses. The continuation of the curing outside the presses is all the greater if the rubber composition is in the form of a bulk object. If the stiffening of the rubber composition is not sufficient at the exit of the press, the viscosity of the rubber composition then allows the bubble formation within the rubber composition when curing continues outside the press. The bubble formation within the rubber composition represents defects in homogeneity in the rubber composition and may result in a decrease in the endurance of the tire containing the rubber composition. It is therefore desirable for the rubber composition, at the end of the curing in the press, to have reached a sufficient stiffness to prevent bubble formation.

Highly saturated elastomers which contain more than 50 mol % of ethylene unit have the particularity of vulcanizing with slower kinetics than highly unsaturated elastomers which contain more than 50 mol % of diene units. Longer residence times in the curing presses are therefore necessary to vulcanize rubber compositions containing highly saturated elastomers, especially if it is desired to avoid the bubbling phenomena mentioned above. The lesser reactivity of highly saturated elastomers with respect to vulcanization thus results in a longer press occupation time by a rubber composition and thus longer production cycles, which has the effect of reducing the productivity of tire tread manufacturing sites.

To reduce the residence time in the presses without being to the detriment of the stiffness of the rubber composition, it is known practice to use an activator for vulcanizing diene elastomers, such as diphenylguanidine, which makes it possible to reduce the vulcanization delay phase. Unfortunately, the use of diphenylguanidine leads to an increase in the hysteresis of the rubber composition, which is detrimental to a good rolling resistance performance of the tire.

### SUMMARY

A solution for reducing residence time in a press with a compromise between stiffness and hysteresis properties of a rubber composition that is less penalizing than the use of diphenylguanidine has been found.

Thus, a first subject of the invention is a tire tread comprising a rubber composition based on at least one highly saturated elastomer, a reinforcing filler and a vulcanization system, the highly saturated diene elastomer containing 1,3-diene units and more than 50 mol % of ethylene units, the vulcanization system comprising a dithiosulfate salt of formula (I),

MO₃S—S-A-S—SO₃M (I)

the symbol A representing an alkanediyl group or a group comprising two or more alkanediyl units, which units are connected in pairs by means of an oxygen or sulfur atom, of a group of formula —SO₂—, —NH—, —NH₂⁺—, —N(C₁-C₁₆ alkyl)— or —COO—, or of an arylene or cycloalkylene group and the symbol M representing a metal atom.

Another subject of the invention is a tire comprising a tread in accordance with the invention.

The invention also relates to a process for manufacturing the tread in accordance with the invention, which process comprises the following steps:
a) incorporating into the highly saturated elastomer the reinforcing filler, where appropriate other ingredients of the rubber composition with the exception of the dithiosulfate salt, sulfur and vulcanization accelerator constituting the vulcanization system,
b) thermomechanically kneading the mixture obtained in step a) until a maximum temperature of between 110° C. and 190° C. is reached,
c) cooling the combined mixture to a temperature of less than 100° C.,
d) then incorporating the dithiosulfate salt, the sulfur and the vulcanization accelerator,
e) kneading everything up to a maximum temperature of less than 110′C, in order to obtain a rubber composition,
f) extruding the rubber composition into a tread.

### DETAILED DESCRIPTION OF EXAMPLE EMBODIMENTS

Any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The compounds mentioned in the description can be of fossil or biobased origin. In the latter case, they may partially or completely result from biomass or be obtained from renewable starting materials resulting from biomass. Elastomers, plasticizers, fillers, etc., are in particular involved.

In the present application, the term “all the monomer units of the elastomer” or “all of the monomer units of the elastomer” is intended to mean all the constituent repeating units of the elastomer that result from the insertion of the monomers into the elastomer chain by polymerization.

The elastomer useful for the requirements of the invention is a highly saturated elastomer which comprises ethylene units resulting from the polymerization of ethylene. In a known manner, the expression “ethylene unit” refers to the —(CH₂—CH₂)— unit resulting from the insertion of ethylene into the elastomeric chain. The elastomer is rich in ethylene units, since the ethylene units represent more than 50 mol % of all the monomer units of the elastomer. Preferably, they represent more than 60 mol % of all the monomer units of the elastomer. More preferentially, the ethylene unit content in the elastomer is at least 65 mol % of all the monomer units of the elastomer. In other words, the highly saturated elastomer contains more than 60 mol % of ethylene units, preferentially at least 65 mol % of ethylene units.

The highly saturated elastomer also comprises 1,3-diene units resulting from the polymerization of a 1,3-diene. In a known manner, the expression “1,3-diene unit” refers to the units resulting from the insertion of the 1,3-diene by a 1,4-addition, a 1,2-addition or a 3,4-addition in the case of isoprene. The 1,3-diene units are those, for example, of a 1,3-diene having 4 to 12 carbon atoms, such as 1,3-butadiene, isoprene, 1,3-pentadiene or an aryl-1,3-butadiene. Preferably, the 1,3-diene is 1,3-butadiene.

According to a first embodiment of the invention, the elastomer contains UD units of formula (I) and where appropriate may contain UE units of formula (II).

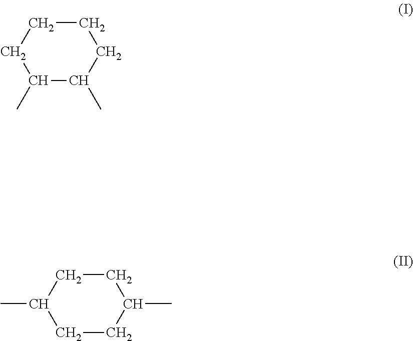

Preferably, the elastomer contains the following UA, UB, UC, UD and UE units distributed statistically according to the molar percentages indicated below

UA) —CH₂—CH₂— according to a molar percentage of m %

UB) —CH₂—CH═CH—CH₂— according to a molar percentage of n %

UC) —CH₂—CH(CH═CH₂)— according to a molar percentage of o %

UD)

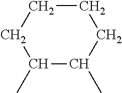

according to a molar percentage of p %

UD)

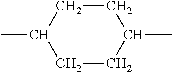

according to a molar percentage of q %
m, n, o, p and q being numbers ranging from 0 to 100,
m>50
n+o>0
p>0
q≥0,
the respective molar percentages of m, n, o, p and q being calculated on the basis of the sum of m+n+o+p+q, which is equal to 100.

More preferentially,
0<o+p≤25
o+p+q≥5
n++o>0
q≥0,
the respective molar percentages of m, n, o, p and q being calculated on the basis of the sum of m+n+o+p+q, which is equal to 100.

Even more preferentially, the elastomer has at least one of the following criteria, and preferentially all of them:
m≥65
n+o+p+q≥15,preferably n+o+p+q≥20
10≥p+q≥2
1≥n/(o+p+q)
when q is non-zero, 20≥p/q≥1.

Advantageously, q is equal to 0.

The highly saturated elastomer is preferentially a copolymer of ethylene and 1,3-butadiene.

Regardless of the embodiment of the invention, including in the variants, the highly saturated elastomer is preferentially random.

The highly saturated elastomer may be obtained according to various synthesis methods known to those skilled in the art, notably as a function of the targeted values of m, n, o, p, q and r. Generally, it can be prepared by copolymerization of at least one 1,3-diene, preferably 1,3-butadiene, and ethylene and according to known synthesis methods, in particular in the presence of a catalytic system comprising a metallocene complex. In this respect, mention may be made of catalytic systems based on metallocene complexes, which catalytic systems are described in documents EP 1 092 731, WO 2004/035639, WO 2007/054223 and WO 2007/054224 in the name of the Applicant.

The highly saturated elastomer useful for the requirements of the invention may consist of a blend of highly saturated diene elastomers which differ from one another in terms of their microstructures or in terms of their macrostructures.

The rubber composition may contain, in addition to the highly saturated elastomer, a second diene elastomer. The term “diene elastomer” is intended to mean an elastomer consisting at least in part (i.e., a homopolymer or a copolymer) of diene monomer units (monomers bearing two conjugated or non-conjugated carbon-carbon double bonds). The second elastomer may be selected from the group of highly unsaturated diene elastomers consisting of polybutadienes, polyisoprenes, butadiene copolymers, isoprene copolymers and a blend thereof. A highly unsaturated elastomer is an elastomer that contains more than 50 mol % of a diene unit.

The content of the highly saturated elastomer in the rubber composition is preferentially greater than 70 parts by weight per hundred parts of elastomer (phr), more preferentially greater than 90 phr. According to one particular embodiment of the invention, the rubber composition contains less than 30 phr of natural rubber, that is to say it contains from 0 to less than 30 phr of natural rubber.

The dithiosulfate salt useful for the requirements of the invention is a compound which bears two groups —S—SO₃M and corresponds to formula (I)

MO₃S—S-A-S—SO₃M (I)

the symbol A representing an alkanediyl group or a group comprising two or more alkanediyl units, which units are connected in pairs by means of an oxygen or sulfur atom, of a group of formula —SO₂—, —NH—, —NH₂+—, —N(C₁-C₁₆ alkyl)— or COO—, or of an arylene or cycloalkylene group and the symbol M representing a metal atom. The dithiosulfate salt may be in the form of a hydrate, in particular monohydrate or dihydrate, thereof.

The term “C₁-C₁₆ alkyl” is intended to mean an alkyl which contains from 1 to 16 carbon atoms.

The dithiosulfate salt belongs to the family of compounds which bear at least two —SSO₃M groups, which are well known compounds, since they are used as an anti-reversion agent in rubber compositions based on natural rubber. The Applicant has discovered that the salt of formula (I) acts as an activator of the vulcanization of highly saturated elastomers containing more than 50 mol % of ethylene units. The use of the salt thus makes it possible to reduce the residence time in the curing press of a rubber composition containing the highly saturated elastomer while conferring on the rubber composition an acceptable compromise between the stiffness and hysteresis properties. Likewise, this compromise is improved in comparison with that obtained in the case where a well-known vulcanization activator such as diphenylguanidine is used instead. The use of the dithiosulfate salt as an activator in the rubber composition is all the more advantageous since the rubber composition is rich in the highly saturated elastomer. A composition is referred to as rich in the highly saturated elastomer provided that it contains more than 70 phr of the highly saturated elastomer, preferably more than 90 phr of the highly saturated elastomer.

The metal atom represented by the symbol M may be an alkali metal atom, an alkaline-earth metal atom or a transition metal atom. The symbol M preferentially denotes an alkali metal atom, more preferentially a sodium or potassium atom, even more preferentially a sodium atom.

The symbol A preferentially denotes an alkanediyl group of formula —(CH₂)ₙ—, n being an integer ranging from 3 to 10, more preferentially a 1,6-hexanediyl group.

The amount of dithiosulfate salt used in the rubber composition is adjusted by those skilled in the art as a function of the desired residence time in the press and as a function of the desired stiffness of the rubber composition. It can vary typically in a range of from 0.5 to 5 phr, preferably from 0.8 to 2 phr. The amount is expressed for the molecule of formula (I). In the case where the thiosulfate salt is used in the form of a hydrate, the part of the water molecule or water molecules in the hydrate form must be taken into account to satisfy the correct content of the dithiosulfate salt of formula (I).

The vulcanization system is a crosslinking system based on sulfur (or a sulfur-donating agent) and on a vulcanization accelerator, in particular a primary accelerator. Various known secondary vulcanization accelerators or vulcanization activators, such as zinc oxide or stearic acid, are added to this base vulcanization system, being incorporated during the non-productive first phase and/or during the productive phase, as described subsequently.

The sulfur is used at a preferential content of between 0.5 and 12 phr, in particular between 1 and 10 phr. The primary vulcanization accelerator is used at a preferential content of between 0.5 and 10 phr, more preferentially of between 0.5 and 5 phr.

It is possible to use as (primary or secondary) accelerator any compound capable of acting as a vulcanization accelerator for diene elastomers in the presence of sulfur, in particular thiazole-type accelerators and also derivatives thereof, in particular accelerators of sulfenamide type. By way of examples of such accelerators, mention may be made in particular of the following compounds: N-cyclohexyl-2-benzothiazole sulfenamide (“CBS”), N,N-dicyclohexyl-2-benzothiazole sulfenamide (“DCBS”), N-tert-butyl-2-benzothiazole sulfenamide (“TBBS”) and mixtures of these compounds.

The reinforcing filler can comprise any type of filler known for its abilities to reinforce a rubber composition which can be used for the manufacture of tires, for example an organic filler, such as carbon black, a reinforcing inorganic filler, such as silica, with which is combined, in a known way, a coupling agent, or else a mixture of these two types of filler.

Such a reinforcing filler typically consists of nanoparticles, the (weight-) average size of which is less than a micrometre, generally less than 500 nm, most often between 20 and 200 nm, in particular and more preferentially between 20 and 150 nm.

All carbon blacks are suitable carbon blacks, in particular the black conventionally used in tire treads (“tire-grade” blacks). The carbon blacks can be used in the isolated state, as available commercially, or in any other form, for example as support for some of the rubber additives used. Mention may be made more particularly of reinforcing carbon blacks of the 100 and 200 or 300 series, or the 500, 600 or 700 series blacks (ASTM grades).

“Reinforcing inorganic filler” should be understood here as meaning any inorganic or mineral filler, irrespective of its colour and its origin (natural or synthetic), also known as “white” filler, “clear” filler or even “non-black” filler, in contrast to carbon black, capable of reinforcing, by itself alone, without means other than an intermediate coupling agent, a diene rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Preferentially, the content of total reinforcing filler is between 20 and 200 phr, more preferentially between 30 and 150 phr, the optimum being, in a known way, different depending on the particular applications targeted: the level of reinforcement expected with regard to a bicycle tire, for example, is of course less than that required with regard to a tire capable of running at high speed in a sustained manner, for example a motorcycle tire, a tire for a passenger vehicle or a tire for a utility vehicle, such as a heavy duty vehicle.

The rubber composition may also comprise all or some of the usual additives normally used in elastomer compositions intended to constitute treads, such as for example plasticizers or extender oils, whether these are aromatic or non-aromatic in nature, in particular very weakly aromatic or non-aromatic oils (e.g., liquid paraffins, hydrogenated naphthenic oils, MES or TDAE oils), vegetable oils, in particular glycerol esters such as glyceryl trioleates, pigments, protective agents such as anti-ozone waxes, chemical anti-ozonants, antioxidants.

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first (non-productive) phase is carried out in a single thermomechanical step during which all the necessary constituents, the optional supplementary processing agents and other various additives, with the exception of the dithiosulfate salt, the sulfur or the sulfur donor and the vulcanization accelerator, are introduced into a suitable mixer such as a conventional internal mixer, The total duration of the kneading, in this non-productive phase, is preferably between 1 and 15 min. After cooling the mixture thus obtained during the first non-productive phase, the dithiosulfate salt, the sulfur or the sulfur donor, and the vulcanization accelerator are then incorporated at low temperature, generally in an external mixer, such as an open mill; everything is then mixed (productive phase) for a few minutes, for example between 2 and 15 min.

According to one preferential embodiment of the invention, the tread according to the invention is prepared by means of a process which comprises the following steps:
a. incorporating into the highly saturated elastomer the reinforcing filler, where appropriate other ingredients of the rubber composition with the exception of the dithiosulfate salt, sulfur and vulcanization accelerator constituting the vulcanization system,
b. thermomechanically kneading the mixture obtained in step a) until a maximum temperature of between 110° C. and 190° C. is reached,
c. cooling the combined mixture to a temperature of less than 100° C.,
d. then incorporating the dithiosulfate salt, the sulfur and the vulcanization accelerator,
e. kneading everything up to a maximum temperature of less than 110′C, in order to obtain a rubber composition,
f. extruding the rubber composition into a tread.

The tread can be either in the raw state (before vulcanization) or in the cured state (after vulcanization).

A better understanding of the abovementioned characteristics of the present invention, and also others, will be obtained on reading the following description of several exemplary embodiments of the invention, given by way of illustration and without limitation.

### Exemplary Embodiments of the Invention

### 1 Tests and Measurements:

### 1-1 Determination of the Microstructure of the Elastomers:

The microstructure of the elastomers is determined by ¹H NMR analysis, supplemented by ¹³C NMR analysis when the resolution of the ¹H NMR spectra does not enable the attribution and quantification of all the species. The measurements are carried out using a Bruker 500 MHz NMR spectrometer at frequencies of 500.43 MHz for observing the proton and 125.83 MHz for observing the carbon.

For elastomers that are insoluble but have the ability to swell in a solvent, an HRMAS 4 mm z-grad probe is used to observe the proton and carbon in decoupled mode of the proton. The spectra are acquired at spin speeds of 4000 Hz to 5000 Hz.

For the measurements of soluble elastomers, a liquid NMR probe is used, making it possible to observe the proton and the carbon in decoupled mode of the proton.

The insoluble samples are prepared in rotors filled with the analyte and a deuterated solvent enabling swelling, in general deuterated chloroform (CDCl₃). The solvent used must always be deuterated and its chemical nature may be adapted by those skilled in the art. The amounts of material used are adjusted so as to obtain spectra with sufficient sensitivity and resolution. The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by those skilled in the art.

In both cases (soluble sample or swollen sample):

For the proton NMR, a simple 30° pulse sequence is used. The spectral window is adjusted to observe all the resonance lines belonging to the molecules analysed. The accumulation number is adjusted in order to obtain a signal to noise ratio that is sufficient for the quantification of each unit. The recycle period between each pulse is adapted to obtain a quantitative measurement.

For the carbon NMR, a simple 30° pulse sequence is used with proton decoupling only during acquisition to avoid the “nuclear Overhauser” effects (NOE) and to remain quantitative. The spectral window is adjusted to observe all the resonance lines belonging to the molecules analysed. The accumulation number is adjusted in order to obtain a signal to noise ratio that is sufficient for the quantification of each unit. The recycle period between each pulse is adapted to obtain a quantitative measurement.

The NMR measurements are carried out at 25° C.

### 1-2 Determination of the Macrostructure of the Elastomers:

Size exclusion chromatography (SEC) is used. SEC makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) can be determined from commercial standards and the polydispersity index.

(PI=Mw/Mn) can be calculated via a “Moore” calibration.

Preparation of the polymer: There is no specific treatment of the polymer sample before analysis. The latter is simply dissolved, in tetrahydrofuran +1 vol % of diisopropylamine +1 vol % of triethylamine +1 vol % of distilled water or in chloroform, at a concentration of approximately 1 g/I. The solution is then filtered through a filter with a porosity of 0.45μm before injection.

SEC analysis: The apparatus used is a Waters Alliance chromatograph. The elution solvent is tetrahydrofuran +1 vol % of diisopropylamine +1 vol % of triethylamine or chloroform, according to the solvent used for the dissolution of the polymer. The flow rate is 0.7 ml/min, the temperature of the system is 35° C. and the analytical time is 90 min. A set of four Waters columns in series, with commercial names Styragel HMW7, Styragel HMW6E and two Styragel HT6E, is used.

The volume of the solution of the polymer sample injected is 100 The detector is a Waters 2410 differential refractometer and the software for making use of the chromatographic data is the Waters Empower system.

The calculated average molar masses are relative to a calibration curve produced from PSS Ready Cal-Kit commercial polystyrene standards.

### 1-3 Dynamic Properties:

The dynamic properties are measured on a viscosity analyser (Metravib VA4000) according to Standard ASTM D 5992-96. The response of a sample of vulcanized composition (cylindrical test specimen with a height of 4 mm and with a cross section of 400 mm²), subjected to a simple alternating sinusoidal shear stress, at a frequency of 10 Hz, at 60° C., is recorded. A strain amplitude sweep is carried out from 0.1% to 100% (outward cycle) and then from 100% to 0.1% (return cycle). The results made use of are the complex dynamic shear modulus G* and the loss factor tan(δ). The value of the G* at 50% strain and also the loss factor, tan(δ)max, are recorded on the return cycle.

### 1-4 Vulcanization Properties:

The measurements are carried out at 150° C. with an oscillating disc rheometer, according to Standard DIN 53529-Part 3 (June 1983). The change in the rheometric torque as a function of time describes the change in the stiffening of the composition as a result of the vulcanization reaction. The measurements are processed according to Standard DIN 53529-Part 2 (March 1983). Ti is the induction period, that is to say the time necessary at the start of the vulcanization reaction, Tα (for example T95) is the time necessary to achieve a conversion of α%, that is to say α% (for example 95%) of the difference between the minimum and maximum torques.

### 2 Preparation of the Rubber Compositions:

Fourteen rubber compositions T1, T2, T3, T4, T5, T6, T7, T8, C1, C2, C3, C4, C5 and C6, the details of the formulation of which are given in Tables 1 and 3, were prepared in the following way:

The elastomer, the reinforcing filler and also the various other ingredients, except for the dithiosulfate salt, the diphenylguanidine, the sulfur and the vulcanization accelerator, are successively introduced into an internal mixer (final degree of filling: approximately 70% by volume), the initial vessel temperature of which is approximately 80° C. Thermomechanical working (non-productive phase) is then carried out in one step, which lasts in total approximately 3 to 4 min, until a maximum “dropping” temperature of 165° C. is reached. The mixture thus obtained is recovered and cooled and then the diphenylguanidine or the dithiosulfate salt, the sulfur and the vulcanization accelerator are introduced into a mixer (homofinisher) at 30° C., everything being mixed (productive phase) for an appropriate time (for example about ten minutes).

All the rubber compositions contain a saturated elastomer. The rubber compositions C1 to C6 are rubber compositions of which the vulcanization system comprises a dithiosulfate salt. The compositions C1 to C3 differ from one another in terms of the dithiosulfate salt content (1 phr, 1.5 phr and 2 phr, respectively). The rubber compositions C4 to C6 are rubber compositions of which the vulcanization system comprises 1.5 phr of a dithiosulfate salt and they are different from one another in terms of the natural rubber content (5 phr, 10 phr and 20 phr, respectively). The rubber composition T1, a control composition, differs from the compositions C1 to C3 in that it does not contain a dithiosulfate salt. The rubber composition T2, a comparative composition, differs from C1 to C3 in that it contains diphenylguanidine (1.5 phr) instead of the dithiosulfate salt. The rubber compositions T3 to T5, compositions that are respectively comparative to C4, C5 and C6, differ from C4 to C6 in that they do not contain a dithiosulfate salt. The rubber compositions T6 to T8, compositions that are respectively comparative to C4, C5 and C6, differ from C4 to C6 in that they contain diphenylguanidine (1.5 phr) instead of the dithiosulfate salt.

The compositions thus obtained are subsequently calendered, either in the form of slabs (thickness of 2 to 3 mm) or of thin sheets of rubber, for the measurement of their physical or mechanical properties, or extruded in the form of a tire tread. The vulcanization properties at 150° C. and the dynamic properties of the rubber compositions are measured after T95 curing at 150° C.

### 3 Results:

The results appear in Table 2 and Table 4.

For the control composition T1, the time required for the start of the vulcanization reaction is greater than 15 minutes. The compositions C1 to C3 which contain the dithiosulfate salt begin to vulcanize at a time of much less than 15 min (respectively 13, 11 and 9.5 minutes): the addition of a dithiosulfate salt makes it possible to reduce this time required for the initiation of the vulcanization by up to more than 30%. This earlier initiation of the vulcanization thus makes it possible to reduce the in-press curing time. This result is obtained without being detrimental to the stiffening, since the stiffnesses of the compositions C1 to C3 are of the same order of magnitude as the control composition T1. Moreover, it is also noted that the hysteresis of compositions C1 to C3 are virtually identical to that of the control composition T1. It can also be seen that a variation of 1 phr to 2 phr of dithiosulfate salt is accompanied by a variation in tan(δ)max of at most 0.02 point. The little influence of the dithiosulfate content on the hysteresis has an advantage in the preparation of the rubber compositions, since it ensures a consistency of the hysteresis properties despite variations in the dithiosulfate content which can range from one to two times. The advantage of the dithiosulfate salt is confirmed in the compositions C4 to C6 containing natural rubber with respect to the control compositions T3 to T5, respectively.

On the other hand, the addition of diphenylguanidine does not give a compromise between the vulcanization properties and the dynamic properties that is as advantageous as the dithiosulfate salt at the same content (1.5 phr). The reduction in the time required for the beginning of the vulcanization reaction obtained with diphenylguanidine is to the detriment of the compromise of stiffness and hysteresis properties, the hysteresis being greatly increased compared to the control composition T1. In the compositions T6 to T8 containing natural rubber, the addition of diphenylguanidine even further degrades the compromise of Ti, stiffness and hysteresis properties with respect to the compositions T3 to T5, respectively. The compositions T6 to T8 exhibit too great a reduction in the Ti and too great an increase in the hysteresis.

In summary, the use of the dithiosulfate salt makes it possible to reduce the residence time in the curing press of a rubber composition containing the highly saturated elastomer while conferring on the rubber composition an acceptable compromise between the stiffness and hysteresis properties. Likewise, this compromise is improved in comparison with that obtained in the case where a well-known vulcanization activator such as diphenylguanidine is used instead.

TABLE 1

| Composition | T1 | T2 | C1 | C2 | C3 |
|---|---|---|---|---|---|
| Elastomer (1) | 100 | 100 | 100 | 100 | 100 |
| Carbon black (2) | 40 | 40 | 40 | 40 | 40 |
| Antioxidant (3) | 2.0 | 2.0 | 2.0 | 2.0 | 2.0 |
| Paraffin | 1.0 | 1.0 | 1.0 | 1.0 | 1.0 |
| Stearic acid (4) | 1.5 | 1.5 | 1.5 | 1.5 | 1.5 |
| Zinc oxide (5) | 2.5 | 2.5 | 2.5 | 2.5 | 2.5 |
| Accelerator (6) | 1.3 | 1.3 | 1.3 | 1.3 | 1.3 |
| Sulfur | 0.6 | 0.6 | 0.6 | 0.6 | 0.6 |
| DPG (7) | 0 | 1.5 | 0 | 0 | 0 |
| Dithiosulfate salt (8) | 0 | 0 | 1.0 | 1.5 | 2.0 |

(1) Elastomer containing 71% UA unit, 8% UB unit, 14% UC unit and 7% UD unit (mol %), prepared according to a process for polymerization of ethylene and butadiene in accordance with example 4-2 of patent EP 1 954 705 B1 in the name of the Applicants, the polymerization time being adjusted so as to obtain a molar mass Mn = 153 000 g/mol with a polydispersity index equal to 1.4
(2) Carbon black of N234 grade according to Standard ASTM D-1765
(3) N-(1,3-Dimethylbutyl)-N-phenyl-para-phenylenediamine, Santoflex 6-PPD from Flexsys
(4) Stearin, Pristerene 4931 from Uniqema
(5) Zinc oxide of industrial grade from Umicore
(6) N-Cyclohexyl-2-benzothiazolesulfenamide, Santocure CBS from Flexsys
(7) Diphenylguanidine
(8) Disodium 1,6-hexamethylene bisthiosulfate dihydrate

TABLE 2

| Composition | T1 | T2 | C1 | C2 | C3 |
|---|---|---|---|---|---|
| Ti (min) | 15.5 | 6.5 | 13 | 11 | 9.5 |
| G* (MPa) | 1.60 | 1.89 | 1.52 | 1.59 | 1.55 |
| tan(δ)max | 0.18 | 0.26 | 0.19 | 0.18 | 0.20 |

TABLE 3

| Composition | T3 | T4 | T5 | T6 | T7 | T8 | C4 | C5 | C6 |
|---|---|---|---|---|---|---|---|---|---|
| Elastomer (1) | 95 | 90 | 80 | 95 | 90 | 80 | 95 | 90 | 80 |
| Elastomer (2) | 5 | 10 | 20 | 5 | 10 | 20 | 5 | 10 | 20 |
| Carbon black (3) | 40 | 40 | 40 | 40 | 40 | 40 | 40 | 40 | 40 |
| Antioxidant (4) | 2.0 | 2.0 | 2.0 | 2.0 | 2.0 | 2.0 | 2.0 | 2.0 | 2.0 |
| Paraffin | 1.0 | 1.0 | 1.0 | 1.0 | 1.0 | 1.0 | 1.0 | 1.0 | 1.0 |
| Stearic acid (5) | 1.5 | 1.5 | 1.5 | 1.5 | 1.5 | 1.5 | 1.5 | 1.5 | 1.5 |
| Zinc oxide (6) | 2.5 | 2.5 | 2.5 | 2.5 | 2.5 | 2.5 | 2.5 | 2.5 | 2.5 |
| Accelerator (7) | 1.3 | 1.3 | 1.3 | 1.3 | 1.3 | 1.3 | 1.3 | 1.3 | 1.3 |
| Sulfur | 0.6 | 0.6 | 0.6 | 0.6 | 0.6 | 0.6 | 0.6 | 0.6 | 0.6 |
| DPG (8) | 0 | 0 | 0 | 1.5 | 1.5 | 1.5 | 0 | 0 | 0 |
| Dithiosulfate | 0 | 0 | 0 | 0 | 0 | 0 | 1.5 | 1.5 | 1.5 |
| salt (9) | | | | | | | | | |

(1) Elastomer containing 71% UA unit, 8% UB unit, 14% UC unit and 7% UD unit (mol %), prepared according to a process for polymerization of ethylene and butadiene in accordance with example 4-2 of patent EP 1 954 705 B1 in the name of the Applicants, the polymerization time being adjusted so as to obtain a molar mass Mn = 153 000 g/mol with a polydispersity index equal to 1.4
(2) Natural rubber
(3) Carbon black of N234 grade according to Standard ASTM D-1765
(4) N-(1,3-Dimethylbutyl)-N-phenyl-para-phenylenediamine, Santoflex 6-PPD from Flexsys
(5) Stearin, Pristerene 4931 from Uniqema
(6) Zinc oxide of industrial grade from Umicore
(7) N-Cyclohexyl-2-benzothiazolesulfenamide, Santocure CBS from Flexsys
(8) Diphenylguanidine
(9) Disodium 1,6-hexamethylene bisthiosulfate dihydrate

TABLE 4

| Composition | T3 | T4 | T5 | T6 | T7 | T8 | C4 | C5 | C6 |
|---|---|---|---|---|---|---|---|---|---|
| Ti (min) | 12.0 | 11.3 | 10.6 | 0.3 | 0.0 | 0.0 | 8.9 | 9.7 | 9.1 |
| G* (MPa) | 1.85 | 1.83 | 1.70 | 1.84 | 1.85 | 1.72 | 1.88 | 1.84 | 1.75 |
| tan(δ)max | 0.20 | 0.20 | 0.21 | 0.26 | 0.27 | 0.26 | 0.20 | 0.21 | 0.21 |

1. A tire tread comprising a rubber composition based on at least one highly saturated elastomer, a reinforcing filler and a vulcanization system, the highly saturated diene elastomer containing 1,3-diene units and more than 50 mol % of ethylene units, the vulcanization system comprising a dithiosulfate salt of formula (I)
MO₃S—S-A-S—SO₃M (I)
the symbol A representing an alkanediyl group or a group comprising two or more alkanediyl units, which units are connected in pairs by means of an oxygen or sulfur atom, of a group of formula —SO₂—, —NH—, —NH₂⁺—, —N(C₁-C₁₆ alkyl)— or 13 COO—, or of an arylene or cycloalkylene group and the symbol M representing a metal atom.

2. A tire tread according to claim 1, in which the highly saturated elastomer contains more than 60 mol % of ethylene units.

3. A tire tread according to claim 1, in which the 1,3-diene is 1,3-butadiene.

4. A tire tread according to claim 1,
in which the highly saturated elastomer contains UD units of formula (I).

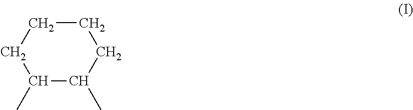

5. A tire tread according to claim 4, in which the highly saturated elastomer contains the following UA units, UB units, UC units, UD units and UE units distributed statistically.
UA) —CH₂—CH₂— according to a molar percentage of m %
UB) —CH₂—CH═CH—CH₂— according to a molar percentage of n %
UC) —CH₂—CH(CH═CH₂)— according to a molar percentage of o %
UD) 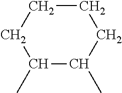
according to a molar percentage of p %
UE) 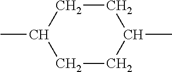
according to a molar percentage of q %
m, n, o, p and q being numbers ranging from 0 to 100,
m>50
n+o>0
p>0
q≥0,
the respective molar percentages of m, n, o, p and q being calculated on the basis of the sum of m+n+o+p+q, which is equal to 100.

6. A tire tread according to claim 5, in which
0<o+p≤25
o+p+q≥5
n+o>0
q≥0,
the respective molar percentages of m, n, o, p and q being calculated on the basis of the sum of m+n+o+p+q, which is equal to 100.

7. A tire tread according to claim 5, in which the highly saturated elastomer has at least one of the following criteria:
a. m≥65
b. n+o+p+q≥15,
c. 10≥p+q≥2
d. 1≥n/(o+p+q)
e. when q is non-zero, 20≥p/q≥1.

8. (canceled)

9. A tire tread according to claim 1, in which the highly saturated elastomer is a copolymer of 1,3-butadiene and ethylene.

10. A tire tread according to claim 1, in which the rubber composition contains more than 70 phr of the highly saturated elastomer.

11. A tire tread according to claim 1, in which the rubber composition contains more than 90 phr of the highly saturated elastomer.

12. A tire tread according to claim 1, in which the rubber composition contains less than 30 phr of natural rubber.

13. A tire tread according to claim 1, in which M denotes an alkali metal atom, an alkaline-earth metal atom or a transition metal atom.

14. A tire tread according to claim 1, in which M denotes a sodium or potassium atom.

15. A tire tread according to claim 1, in which A denotes an alkanediyl group of formula —(CH₂)ₙ—, n being an integer ranging from 3 to 10.

16. (canceled)

17. A tire tread according to claim 1, in which the salt content represents from 0.5 to 5 phr.

18. A tire tread according to claim 1, in which the reinforcing filler comprises a carbon black.

19. A tire tread according to claim 1, in which the vulcanization system comprises sulfur and a vulcanization accelerator that is a sulfenamide.

20. A tire comprising a tread defined according to claim 1.

21. A process for manufacturing a tread defined according to claim 1, which process comprises the following steps:
a. incorporating into the highly saturated elastomer the reinforcing filler, where appropriate other ingredients of the rubber composition with the exception of the dithiosulfate salt, sulfur and vulcanization accelerator constituting the vulcanization system,
b. thermomechanically kneading the mixture obtained in step a) until a maximum temperature of between 110° C. and 190° C. is reached,
c. cooling the combined mixture to a temperature of less than 100° C.,
d. then incorporating the dithiosulfate salt, the sulfur and the vulcanization accelerator,
e. kneading everything up to a maximum temperature of less than 110° C., in order to obtain a rubber composition,
f. extruding the rubber composition into a tread.

22. A tread according to claim 5 in which the highly saturated elastomer has all of the following criteria:
a. m≥65
b. n+o+p+q≥15,preferably n+o+p+q≥20
c. 10≥p+q≥2
d. 1≥n/(o+p+q)
e. when q is non-zero, 20≥p/q≥1.
